(19) United States
(12) Patent Application Publication
(10) Pub. No.: US 2004/0171347 A1
(43) Pub. Date: Sep. 2, 2004

(54) Method and system for sending signals over a network with mobile nodes

(76) Inventors: Joshua W. Burton, Skokie, IL (US); Ezekiel J. Emanuel, Evanston, IL (US)

Correspondence Address: Ansel M. Schwartz, Suite 304, 201 N. Craig Street, Pittsburgh, PA, 15213, US

(21) Appl. No.: 10/377,055

(22) Filed: Feb. 28, 2003

(51) Int. Cl. H04B 7/15

(52) U.S. Cl. 455/11.1; 455/345

(57) ABSTRACT

A telecommunications system for sending signals over a network including a plurality of mobile nodes. Each mobile node includes a motor vehicle, a wireless transmitter disposed with the motor vehicle having a range for transmitting signals to the network, a wireless receiver disposed with the motor vehicle for receiving signals from the network, a memory disposed with a motor vehicle for storing the signals, a router disposed with the motor vehicle for routing the signals along the network, and an energy source disposed with the motor vehicle for powering the router. The system includes a fixed node. The fixed node preferably has a transmitter for transmitting signals to the network and a receiver for receiving signals from the network. Each mobile node communicates with the fixed node directly if the mobile node is within the range of the fixed node, or indirectly to the fixed node through at least one other mobile node of the plurality of mobile nodes if the mobile node is outside the range of the fixed node. A method for sending telecommunications signals over a network.

### FIELD OF THE INVENTION

The present invention relates to a telecommunications system for cars and homes. More specifically, the present invention relates to a telecommunications system for cars and homes that uses routers in cars to communicate and send signals between and on to other cars and homes or fixed locations.

### BACKGROUND OF THE INVENTION

Among the many unfulfilled promises created by the Internet implosion, there are two that initially appear completely disconnected but can be solved simultaneously: telematics in cars and high speed Internet connections to homes.

In the 4 years since it began to attract investor interest, telematics of the automobile has failed to realize much of its bright promise. Other than the general Internet implosion, the likely reasons for this failure are:

(1) the mismatch between the pace of innovation in the digital world, measured in months, and product development times in the automotive industry, measured in-years;

(2) the extreme importance of a useful but non-distracting user interface in the safety-critical environment of the automobile cockpit; and

(3) the classic “chicken-and-egg” network effect common to all infrastructions, where the benefits of the technology cannot be fully realized until it is widely deployed.

To spark the promised revolution, a successful technology would need to fulfill at least three requirements:

(1) to be largely self-contained and suited to speedy adoption;

(2) to be transparent to the driver; and

(3) to be economically self-justifying without closing the door to diverse future innovation.

The goal is not to solve all the problems at once. Instead, the objective is to develop and deploy a functioning network system into as many automobiles as possible, with reasonable assurance that many stakeholders—from the drivers to advertisers to repair shops to law enforcement—have sufficient reason to utilize the introductory network services. Once established, additional services can be added, attracting additional stakeholders, expanding the network and thereby enhancing the value for all stakeholders.

A complementary problem afflicts the broadband sector of the telecom industry. The Internet uses multiple-hop, ad-hoc networking. To make it commercially viable, this approach had to ensure data integrity, confidentiality, and a reliable high-standard quality of service. Over the last two decades, the engineering challenges associated with meeting these goals using the Internet have been solved. The promise of providing innovative and profitable technologies in the home utilizing the open architecture of the Internet protocol, attracted substantial investment in broadband.

However, the “last mile” problem—the lack of flexibility and rapidly deployed broadband links to the end user in the home or small office—has left much of the installed fiber dark and many of its owners bankrupt. Many types of wireless networks, such as third generation cell phones, medium-range Wi-Fi, and short-range Bluetooth networks, promised to overcome the cable and twisted-pair access bottlenecks by utilizing low-power networks in unregulated segments of the radio spectrum for communication between local devices. Each of these wireless approaches to networking has problems. But the common and most important problem is the need for fixed towers to provide a backbone near enough to the end user. Buying rights, gaining approvals, and building these towers has been expensive.

### SUMMARY OF THE INVENTION

The present invention pertains to a telecommunications system for sending signals over a network. The system comprises a plurality of mobile nodes. Each mobile node includes a motor vehicle, a wireless transmitter disposed with the motor vehicle having a range for transmitting signals to the network, a wireless receiver disposed with the motor vehicle for receiving signals from the network, a memory disposed with a motor vehicle for storing the signals, a router disposed with the motor vehicle for routing the signals along the network, and an energy source disposed with the motor vehicle for powering the router. The system comprises a fixed node. The fixed node preferably has a transmitter for transmitting signals to the network and a receiver for receiving signals from the network. Each mobile node communicates with the fixed node directly if the mobile node is within the range of the fixed node, or indirectly to the fixed node through at least one other mobile node of the plurality of mobile nodes if the mobile node is outside the range of the fixed node.

The present invention pertains to a method for sending telecommunications signals over a network. The method comprises the steps of sending the signals from a wireless transmitter of a mobile node disposed with a motor vehicle of the mobile node to a wireless receiver of an other mobile node disposed with a motor vehicle of the other mobile node of a plurality of mobile nodes. There is the step of routing with a router of the other mobile node the signal to the fixed node. There is the step of transmitting the signal from the other mobile node to the fixed node.

### BRIEF DESCRIPTION OF THE DRAWINGS

In the accompanying drawings, the preferred embodiment of the invention and preferred methods of practicing the invention are illustrated in which:

FIG. 1 is a schematic representation of the system of the present invention.

### DETAILED DESCRIPTION

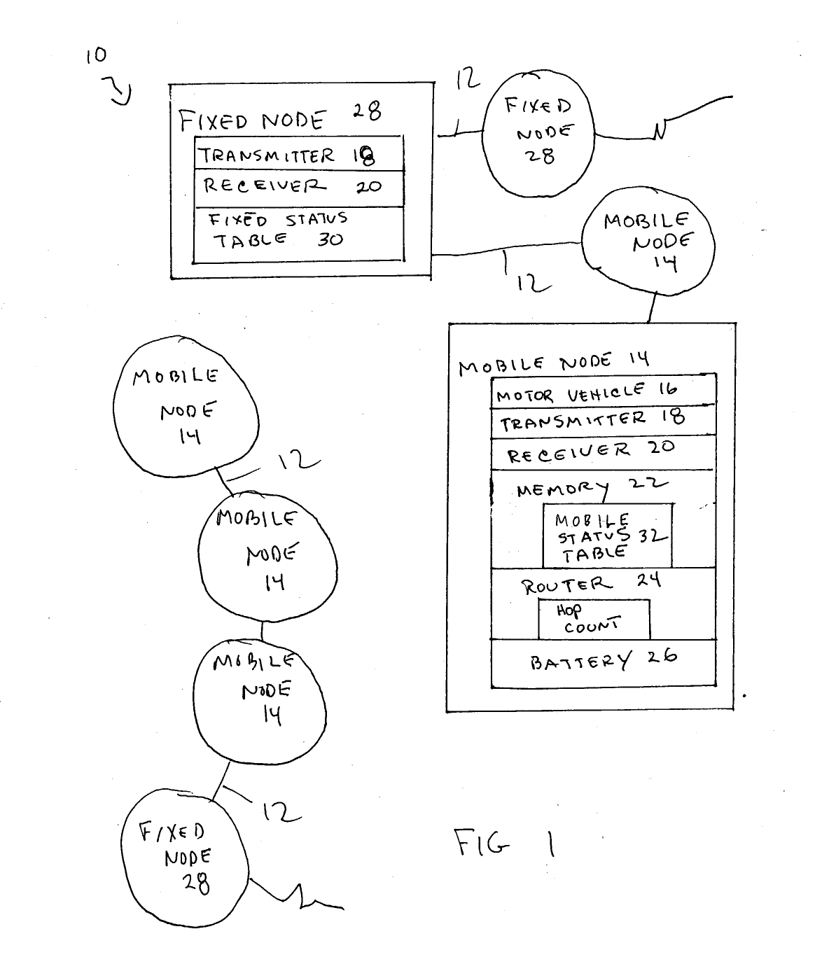

Referring now to the drawings wherein like reference numerals refer to similar or identical parts throughout the several views, and more specifically to FIG. 1 thereof, there is shown a telecommunications system 10 for sending signals over a network 12. The system 10 comprises at least one, and preferably a plurality of mobile nodes 14. Each mobile node 14 includes a motor vehicle 16, a wireless transmitter 18 disposed with the motor vehicle 16 having a range for transmitting signals to the network 12, a wireless receiver 20 disposed with the motor vehicle 16 for receiving signals from the network 12, a memory 22 disposed with a motor vehicle 16 for storing the signals, a router 24 disposed with the motor vehicle 16 for routing the signals along the network 12, and an energy source 26 disposed with the motor vehicle 16 for powering the router 24. The system 10 comprises a fixed node 28. The fixed node 28 preferably has a transmitter 18 for transmitting signals to the network 12 and a receiver 20 for receiving signals from the network 12. Each mobile node 14 communicates with the fixed node 28 directly if the mobile node 14 is within the range of the fixed node 28, or indirectly to the fixed node 28 through at least one other mobile node 14 of the plurality of mobile nodes 14 if the mobile node 14 is outside the range of the fixed node 28. Signal herein refers to any type of data, including signaling information. A fixed node 28 can be a cell phone, a computer with wireless capability, a transmission and/or receive station of an established network 12, a laptop or a cell phone in a bus or a car, to name but a few of the many possible examples. A mobile node 14 differs from a fixed node 28 in that the mobile node 14 is not fixed in place to any location, in other words, the mobile node 14 is movable or portable, has a router 24 and a power source that moves with the router 24. A laptop having a router 24 plugged into a cigarette lighter outlet of a car is a mobile node 14, as well as a laptop with a router 24 that runs on its own battery. Of course, it also has a transmitter 18 and a receiver 20.

Preferably, the router 24 keeps a hop count of how many mobile nodes 14 are needed to communicate through to communicate with the fixed node 28. The mobile node 14 preferably transmits signals with its transmitter 18 in packets that include the hop count of the mobile node 14 at the time the packet is transmitted. Preferably, the mobile node 14 transmits packets to the network 12 to determine what other mobile nodes 14 of the plurality of mobile nodes 14 are within its range, and the mobile node 14 transmits a packet in response to any packet it receives to an other mobile node 14 of the plurality of mobile nodes 14 or the fixed node 28 that transmitted the packet that the mobile node 14 received.

The mobile node 14 preferably chooses to communicate with the fixed node 28 through an other mobile node 14 of the plurality of mobile nodes 14 which has a lowest hop count of the other mobile nodes 14. Preferably, the node at send predetermined times sends a packet to the fixed node 28 or any other mobile node 14 of the plurality of mobile nodes 14 from which it received a packet within a receive predetermined time. A packet preferably includes a unique identifier of the hardware of the mobile node 14 that transmits the packet.

Preferably, the mobile node 14 continues to transmit packets until the mobile node 14 receives a packet from another mobile node 14 of the plurality of mobile nodes 14 indicating the other mobile node 14 has received the packet from the mobile node 14. The fixed node 28 preferably contains a fixed status table 30 having information about all mobile nodes 14 that are at least one hop count from the fixed node 28. Preferably, the mobile node 14 maintains a mobile status table 32 having information about all other mobile nodes 14 that are at least wireless one hop count from the mobile node 14.

The present invention pertains to a method for sending telecommunications signals over a network 12. The method comprises the steps of sending the signals from a wireless transmitter 18 of a mobile node 14 disposed with a motor vehicle 16 of the mobile node 14 to a wireless receiver 20 of another mobile node 14 disposed with a motor vehicle 16 of the other mobile node 14 of a plurality of mobile nodes 14. There is the step of routing with a router 24 of the other mobile node 14 the signal to the fixed node 28. There is the step of transmitting the signal from the other mobile node 14 to the fixed node 28.

Preferably, there is the step of maintaining with the router 24 a hop count of how many mobile nodes 14 are needed to communicate through to communicate with the fixed node 28. There is preferably the step of transmitting signals with the transmitter 18 of the mobile node 14 in packets that include the hop count of the mobile node 14 at the time the packet is transmitted. Preferably, there is the step of transmitting with the mobile node 14 packets to the network 12 to determine what other mobile nodes 14 of the plurality of mobile nodes 14 are within the mobile node's 14 range.

There is preferably the step of transmitting with the mobile node 14 a packet in response to any packet it receives to an other mobile node 14 of the plurality of mobile nodes 14 or the fixed node 28 that transmitted the packet that the mobile node 14 received. Preferably, there is the step of choosing by the mobile node 14 to communicate with the fixed node 28 through an other mobile node 14 of the plurality of mobile nodes 14 which has a lowest hop count of the other mobile nodes 14. There is preferably the step of sending with the mobile node 14 at predetermined times a packet to the fixed node 28 or any other mobile node 14 of the plurality of mobile nodes 14 from which it received a packet within a receive predetermined time.

Preferably, there is the step of the step of sending a packet to the network 12 with the mobile node 14 which includes a unique identifier of the hardware of the mobile node 14. There is preferably the step of continuing by the mobile node 14 to transmit packets until the mobile node 14 receives a packet from another mobile node 14 of the plurality of mobile nodes 14 indicating the other mobile node 14 has received the packet from the mobile node 14. Preferably, there is the step of the step of maintaining with the fixed node 28 a fixed status table 30 having information about all mobile nodes 14 that are at least one hop count from the fixed node 28. There is preferably the step of the mobile node 14 maintaining with the mobile node 14 a mobile status table 32 having information about all other mobile nodes 14 that are at least one hop count from the mobile node 14.

In the operation of the invention, one approach can solve the “last-mile” problem with broadband and telematics for the automobile simultaneously—A Car-Based Internet Network 12 System 10.

Imagine that each of a few million automobiles contained a medium-range network 12 router 24. Each router 24 is a black box with the following characteristics:

Operates a common wireless protocol

Linked to other land-based or automobile-based routers 24 without user interaction

Weight—1-2 pounds

Energy consumption—in the range of a typical cell phone adapter

Range—0.5 km to 1 km.

Each automobile would link either to a fixed land-based router 24, or to another automobile that is one hop closer to such a router 24. In any given area, a background stream of handshaking packets between nearby land-based or automobile-based nodes would maintain the network 12 system 10. The land-based nodes could be connected to each other by ordinary high-bandwidth data backbones, such as fiber optic or coaxial cables. Each land-based node would then have its effectiveness—range—multiplied by the many mobile nodes 14 through which it directly or indirectly communicates to end-users. Taken as a system, the entire set of a few million deployed routers 24 would constitute the most ramified general-purpose digital network 12 in existence.

What makes this approach possible and so powerful is that the automobile is a mobile platform, with an independent low-voltage power supply, that is permitted without special easement to sit in the middle of a public thoroughfare anywhere in the United States, and that dynamically tracks the location of potential network 12 users, to such a degree that few people are more than a few hundred yards from an automobile for more than a few hours a month.

To put it another way, this Car-based Internet Network 12 System (CINS) has several unique features:

(1) CINS automatically extends itself to where people are. Cars track people. As people move into each new housing subdivision, as people drive down highways in the morning rush hour, the network 12 extends.

(2) CINS is virtually free because it does not have the “tower problem.” Unlike conventional telecommunication providers, this wireless Internet network 12 system 10 is not dependent upon building thousands of towers in communities. CINS does not require easements to be located near the end user.

Each router 24 in a car should have at least a range of approximately 0.5 to 1 kilometer. For reference having an antenna range of 250 meters (0.25 kilometers) requires a car on every city block.

Existing WiFi networks using 802.11b and its successor technologies—802.11a and 802.11g—achieve reliable ranges 50-100 meters (0.05 to 0.1 kilometers) utilizing omnidirectional antennae. Because they were designed for portable computers, these WiFi networks were designed to operate under significant size and energy constraints. Specifically, they must be small enough to fit in a laptop peripheral slot and draw very little energy from the computer's battery. They provide no quality of service guarantees. At the other end, hobbyists have achieved ranges of up to 10 kilometers with standard WiFi utilizing directional antennae. Some companies have proposed new proprietary protocols that improve on normal WiFi range while utilizing little energy and achieving quality of service guarantees.

Automobiles do not face the same size and energy constraints as portable computers. Five pounds is negligible weight for a car; and cars have comparatively large amounts of power. These characteristics permit the design of relative cheap router-antennae for automobile network routers 24 that can have a range of 0.5 to 1 kilometer that weighs about 1 pound, and preferably under 5 pounds, and consumes very little energy, on the order of a cell phone.

Speed—Currently, telephone lines transmit data at 56 kilobits per second. Good cell phone voice signals consume less than 20 kilobits per second. A good web browsing experience is possible at 200 kilobits per second; a very good Web experience requires 1,000 kilobits per second or 1 megabit per second. To put that into perspective, at speeds of 1,000 kilobits per second, about 8 seconds is required to upload a minute of CD-quality music in compressed format.

The speed required in the automobile network 12—CINS—should be roughly 1,000 kilobits per second or 1 megabit per second. This is an intermediate speed, far slower than the 11 to 54 megabits per second of WiFi based local area networks. Nevertheless, it permits a very good Web browsing experience and it exceeds the speeds of the next generation cell phone networks. Furthermore, the comparatively low speed makes the range of 0.5 to 1 kilometer goal easily achieved.

Durability—Clearly an automobile based router 24 and antenna needs to last as long as the automobile. Thus, the router 24 and antenna need to be able to withstand the bumps and jolts of 100,000 to 150,000 miles, and the thermal stresses of summer and winter operation. Such durability is certainly achievable, building off the successes of network cards in modern portable computers. (A more extreme example is the off-the-shelf wireless modem used by the Mars Pathfinder rover to communicate with its base station at temperatures fifty degrees colder than a Minnesota winter.)

Quality Standard of Service—The quality of service provided by CINS should depend upon the applications being provided. Clearly, for cell phone and downloading music or movies, the system 10 must ensure that the connection is clear and maintained for the entire length of the interaction. Thus, the software protocol should provide for quality of service when handling cell phone or music or movie downloading. Conversely, for web browsing, the system 10 should provide best effort.

Importantly, it is relatively easy to build both types of service standards into the software protocol because the protocol will be built for the system 10. Datastream reliability is already provided at the logical TCP/IP layer, but there is no way to retrofit real-time quality-of-service guarantees unless the underlying physical transport layer supports them.

Privacy—The protocol must include an encryption layer. However, it probably prudent to provide only a minimal encryption product. The open nature of the Internet TCP/IP end point protocol allows users who want more secure guarantees of privacy to apply their own more sophisticated encryption protocols on top of the CINS information transfer.

Another important requirement for the encryption layer is authentication. This is necessary for identifying and authenticating endpoint users for e-commerce services.

A fundamental question in creating the CINS is how many automobiles need to be equipped with the router 24 and antenna to make the network 12 system 10 functional. The answer depends upon both the range of the antenna and automobile density. If the antennae have a range of 0.5 kilometers, then network 12 service can be achieved with one automobile carrying the router 24 and antenna per 10 acres. This is a conservative estimate; that is, it includes a safety range. This means that after just one year of deployment, every city in the United States should have sufficient number of automobiles and trucks equipped with the router 24 and antenna to make the network 12 functional.

What is the basis of this calculation? There are roughly 200 million automobiles and trucks in the United States. Assume a major car company sells approximately 3 million new automobiles and trucks per year. If there are 60 cars per 10 acres, then there is likely to be one new automobile or truck within those 10 acres. Therefore, in one year, there are likely to be a new automobile or truck carrying the router 24 and antenna per 10 acres. This means that in the first year of deployment, every neighborhood in the United States that has 60 cars per 10 acres, or a mere 6 cars per acre, will be able to receive service from the car-based network 12. At the end of 2 model years, every neighborhood with 3 cars per acre will be within the CINS. Consequently, after only 1 year of deployment, almost all cities in the United States will be covered. After just 2 years of deployment, most small towns in the United States should be covered by CINS.

There are clearly numerous advantages to this proposed Car-Based Internet Network 12 System 10. It can overcome the “last mile” problem delivering broadband links to the Internet to homes and other end users without building towers or laying cable. It also can begin to solve the telematics problem for the car. For the driver and people in the automobile, it will permit better, more clear and uninterrupted cell phone conversations. Furthermore, CINS allows people in automobiles to gain access to the Internet and also to gain access to their computer files at home instantaneously. It also might provide people in cars opportunities to pay for gas as they pull into a service station or to order ahead at fast food restaurants.

For advertisers, rental and corporate fleet operators, and marketers, it provides an opportunity to track cars and provide customized information to cars. Most importantly, it allows numerous contacts with a car and the people in the car that we have not yet dreamed of.

More specifically, an established network 12 of fixed nodes 28 is assumed. The mobile nodes 14 are mobile by virtue of being attached to automobiles. The network 12 containing both fixed and mobile nodes 14 will signal a network 12 of fixed nodes 28 with a time to live of one second. Therefore, the network 12 will be refreshed each second.

The mobile nodes 14 have a range of at least one hundred meters. The mobile nodes 14 are moving no faster than 30 meters/second. Given these parameters, each mobile node 14 is likely to be within range of the nearby mobile nodes 14 for approximately 3 seconds. That is, in 3 seconds, one mobile node 14 will have moved approximately 90 meters and the other mobile node 14 will also have moved 90 meters. Thus, if the range of the antennae is 200 meters, then these mobile nodes 14 should be in contact with each other for 3 seconds or more.

There is a fixed node 28 that receives packets of information. The packets contain the following information: 1) unique identification of the hardware that is at the node, and 2) an integer count of how many mobile nodes 14 they are away from the fixed node 28. When the packet of information is at the fixed node 28, the hop count is 0. At the first mobile node 14 from the fixed node 28, the hop count is 1 and so on.

The fixed node—A—sends a packet of information that is received by the first mobile node—mobile node B. At this point, the hop count is 1. The first mobile node then relays the packet of information to a second mobile node—node C. At this point, the hop count is 2.

At least once a second, the mobile node B will send a signal to the fixed node A from which it received the packet of information. Similarly, mobile node C will send a signal to the mobile node B from which it received a packet of information. Fixed node A will send a signal acknowledging receipt of the signal from the mobile node B. Similarly, the mobile node B will send a signal acknowledging the receipt of the signal from mobile node C. In return, mobile node C will close the message acknowledging it received the packet.

If mobile node C does not receive a signal from mobile node B acknowledging receipt of the signal, then mobile node C will be orphaned. Mobile node C will then broadcast a ping to all nearby nodes. Any nodes hearing a ping will respond within 1 second with an acknowledgment, transmitting information about how many intervening mobile nodes 14 they are from the fixed node. These mobile nodes 14 will be able to transmit this information because they know the “count” of their information. Mobile node C that has lost contact with mobile node B will randomly choose among replying nodes with the lowest hop count. Say mobile node C chooses mobile node D with a count of 1. Mobile node C will pass off its information packet to mobile node D because it has the lowest hop count. If mobile node C sends the information packet to mobile node D and the mobile node D acknowledges receipt the transfer of the packet of information, the transmission is successful. If mobile node C fails to receive an acknowledgment, then mobile node C chooses another mobile node 14 with a hop count of 1—say mobile node E or F. If none of the first three choices are successful, mobile node C would then ping for help again. Every node is aware of its own hop count and prepared to respond to any ping from another node with the information of its hop count.

Simultaneously, with every acknowledgment of receipt of a packet of information, mobile node C forwards routing information (IP address) about mobile node D (those with higher hop count) to mobile node B which in turn forwards this information to fixed node A. Fixed node A is maintaining the information about all the mobile nodes that are one hop away—all mobile nodes B. And since these contain information on mobile nodes further away from the fixed line, this fixed line knows how many mobile nodes there are and how many hops they are from the fixed line. TCP will handle drops. TCP will send same packet if the mobile nodes drop.

The problem that a mesh network 12 has to solve, above and beyond the static routing problem the Internet itself has to deal with, is just exactly that the routings are likely to change on a short (<1 sec) timescale. If the system 10 has to understand its own global connectivity, and revise it all that often (as routing tables and domain name service on the Internet do) updates would overcome the system 10, and data would never be sent. Luckily, only the next one step is needed to be known, to send a packet “closer” to where it needs to go. If every node knows which way is upstream, and is no more than 0.1 sec out of date (3 meters at freeway speeds; compare to 100 to 500 meter range for various existing transmission technologies using unlicensed spectrum, such as 802.11b, -a, and -g), then most of the time a packet that blindly heads for a lower hop count will reach a fixed node 28. If it doesn't, the normal Internet protocol (IP) provides a time-to-live count that will eventually cause it to die peacefully, rather than circling forever between mobile nodes 14. The normal transport control protocol (TCP) that resides on top of IP keeps track of packets that arrive late or get lost, creating a reliable one- or two-way comm channel out of unreliable packet delivery.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A telecommunications system for sending telecommunication signals over a network comprising:
a plurality of mobile nodes, each mobile node including a motor vehicle, a wireless transmitter disposed with the motor vehicle having a range for transmitting signals to the network, a wireless receiver disposed with the motor vehicle for receiving signals from the network, a memory disposed with the motor vehicle for storing the signals, a router disposed with the motor vehicle for routing the signals along the network, and an energy source disposed with the motor vehicle for powering the router; and
a fixed node, the fixed node having a transmitter for transmitting signals to the network and a receiver for receiving signals from the network, each mobile node communicating with the fixed node directly if the mobile node is within the range of the fixed node, or indirectly to the fixed node through at least one other mobile node of the plurality of mobile nodes if the mobile node is outside the range of the fixed node.

2. A system as described in claim 1 wherein the router keeps a hop count of how many mobile nodes are needed to communicate through to communicate with the fixed node.

3. A system as described in claim 2 wherein the mobile node transmits signals with its transmitter in packets that include the hop count of the mobile node at the time the packet is transmitted.

4. A system as described in claim 3 wherein the mobile node transmits packets to the network to determine what other mobile nodes of the plurality of mobile nodes are within its range, and the mobile node transmits a packet in response to any packet it receives to an other mobile node of the plurality of mobile nodes or the fixed node that transmitted the packet that the mobile node received.

5. A system as described in claim 4 wherein the mobile node chooses to communicate with the fixed node through an other mobile node of the plurality of mobile nodes which has a lowest hop count of the other mobile nodes.

6. A system as described in claim 5 wherein the mobile node at predetermined times sends a packet to the fixed node or any other mobile node of the plurality of mobile nodes from which it received a packet within a receive predetermined time.

7. A system as described in claim 6 wherein a packet includes a unique identifier of the mobile node that transmits the packet.

8. A system as described in claim 7 wherein the mobile node continues to transmit packets until the mobile node receives a packet from an other mobile node of the plurality of mobile nodes indicating the other mobile node has received the packet from the mobile node.

9. A system as described in claim 8 wherein the fixed node contains a fixed status table having information about all mobile nodes that are at least one hop count from the fixed node.

10. A system as described in claim 9 wherein the mobile node maintains a mobile status table having information about all other mobile nodes that are at least wireless one hop count from the mobile node.

11. A method for sending telecommunications signals over a network comprising the steps of:
sending the signals from a wireless transmitter of a mobile node disposed with a motor vehicle of the mobile node to a wireless receiver of an other mobile node disposed with a motor vehicle of the other mobile node of a plurality of mobile nodes;
routing with a router of the other mobile node the signal to the fixed node; and
transmitting the signal from the other mobile node to the fixed node.

12. A method as described in claim 11 including the step of maintaining with the router a hop count of how many mobile nodes are needed to communicate through to communicate with the fixed node.

13. A method as described in claim 12 including the step of transmitting signals with the transmitter of the mobile node in packets that include the hop count of the mobile node at the time the packet is transmitted.

14. A method as described in claim 13 including the step of transmitting with the mobile node packets to the network to determine what other mobile nodes of the plurality of mobile nodes are within the mobile node's range.

15. A method as described in claim 14 including the step of transmitting with the mobile node a packet in response to any packet it receives to an other mobile node of the plurality of mobile nodes or the fixed node that transmitted the packet that the mobile node received.

16. A method as described in claim 15 including the step of choosing by the mobile node to communicate with the fixed node through another mobile node of the plurality of mobile nodes which has a lowest hop count of the other mobile nodes.

17. A method as described in claim 16 including the step of sending with the mobile node at predetermined times a packet to the fixed node or any other mobile node of the plurality of mobile nodes from which it received a packet within a receive predetermined time.

18. A method as described in claim 17 including the step of sending a packet to the network with the mobile node which includes a unique identifier of the hardware of the mobile node.

19. A method as described in claim 18 including the step of continuing by the mobile node to transmit packets until the mobile node receives a packet from an other mobile node of the plurality of mobile nodes indicating the other mobile node has received the packet from the mobile node.

20. A method as described in claim 19 including the step of maintaining with the fixed node a fixed status table having information about all mobile nodes that are at least one hop count from the fixed node.

21. A method as described in claim 20 including the step of the mobile node maintaining with the mobile node a mobile status table having information about all other mobile nodes that are at least one hop count from the mobile node.

22. A mobile node for sending telecommunication signals over a network comprising:
a motor vehicle;
a wireless transmitter disposed with the motor vehicle having a range for transmitting signals to the network;
a wireless receiver disposed with the motor vehicle for receiving signals from the network;
a memory disposed with the motor vehicle for storing the signals;
a router disposed with the motor vehicle for routing the signals along the network; and
an energy source disposed with the motor vehicle for powering the router.
